(19) United States
(12) Patent Application Publication
(10) Pub. No.: US 2014/0180476 A1
(43) Pub. Date: Jun. 26, 2014

(54) METHOD, APPARATUS, AND COMPUTER PROGRAM PRODUCT FOR THE DISPENSING AND IDENTIFICATION OF MEDICATION

(71) Applicant: MCKESSON AUTOMATION INC., Cranberry, PA (US)

(72) Inventors: Robert Jaynes, Mars, PA (US); Dave Deutsch, Cranberry Township, PA (US)

(73) Assignee: McKesson Automation Inc., Cranberry, PA (US)

(21) Appl. No.: 13/722,657

(22) Filed: Dec. 20, 2012

(51) Int. Cl. G06F 19/00

(52) U.S. Cl. CPC G06F 19/3462
USPC 700/244

(57) ABSTRACT

Example embodiments of the present invention may provide an efficient method of identifying unit doses of medication, and more specifically, to dispensing, identifying, packaging, and marking unit doses of medication for distribution. In particular, methods may include receiving a plurality of unit dose medications, dispensing one of the plurality of unit dose medications, and capturing an image of the one of a plurality of unit dose medications. The method may also compare the captured image to a database of known medications, where each known medication includes a medication type and a medication dose. In response to the captured image satisfying a confidence threshold match to one of the known medications, the one of the plurality of unit dose medications may be identified. Dispensing one of the plurality of unit dose medications may include dispensing one of the plurality of unit dose medications to a unit dose package.

### FIELD OF THE INVENTION

The present invention relates to the identification of articles in an automated dispensing system, and more particularly to providing a method, apparatus, and computer program product for ensuring accuracy and efficiency of the identification of medications dispensed in an automated pharmaceutical dispensing system.

### BACKGROUND

Medications are an important part of an effective healthcare system and it is important that medications are properly prescribed, distributed, and consumed. Advances in medication development have led to a proliferation of available medications for virtually any health condition. The vast number of medications available for patients can require pharmacies and hospitals to maintain very large inventories of medications with hundreds of types available at any given time. The large number of medications available may increase the likelihood of distributing the incorrect medication type or dosage to a patient. Manual verification of medicines, including the type and dosage, is generally required to minimize errors in distribution. However, as the number of available medications increases, the number of medications distributed to patients similarly increases. This increase has led to the automation of various steps of the medication distribution process.

Automated dispensing and packaging of medications is a process which must be executed with great accuracy to ensure patient safety and to minimize possible errors. Due to various phases of the distribution process, from the manufacturer to the wholesale distributor to the pharmacy to the patient, automation can be implemented in one or all of the distribution phases. However, upstream errors in packaging can be problematic if not caught before dispensing to a patient. Therefore, manual verification is still generally required to ensure accuracy of medication identification before it is distributed to a patient. Provided herein is an invention to improve the accuracy and efficiency of automated medication identification, packaging, and distribution.

### SUMMARY

Example embodiments of the present invention may provide an efficient method of identifying unit doses of medication, and more specifically, to dispensing, identifying, packaging, and marking unit doses of medication for distribution. In particular, methods may include receiving a plurality of unit dose medications, dispensing one of the plurality of unit dose medications, and capturing an image of the one of a plurality of unit dose medications. The method may also compare the captured image to a database of known medications, where each known medication includes a medication type and a medication dose. In response to the captured image satisfying a confidence threshold match to one of the known medications, the one of the plurality of unit dose medications may be identified. Dispensing one of the plurality of unit dose medications may include dispensing one of the plurality of unit dose medications to a unit dose package.

Methods of example embodiments may include writing identifying information to the unit dose package of the one of the plurality of unit dose medications in response to identifying the one of the plurality of unit dose medications. The identifying information may be written by encoding a radio frequency identification tag associated with the unit dose package or printing identifying information to the unit dose package. Comparing the captured image to the database of known medications may include comparing a color, size and/or a shape of the one of the plurality of unit dose medications with the colors, sizes, and/or shapes of the known medications. In response to the captured image not satisfying a confidence threshold match to one of the known medications, the one of the plurality of unit dose medications may be diverted to a manual check location. In response to the captured image failing to satisfy a confidence threshold match to one of the known medications, an alert may be provided.

According to some embodiments of the invention, an apparatus may be provided for identifying unit dose medication. The apparatus including a dispenser for dispensing an individual unit dose medication to unit dose packaging, an image capture device for capturing an image of the individual unit dose medication, a database of known medications, and an information writing device. The image captured of the individual unit dose medication may be compared with the database of known medications in order to identify the individual unit dose medication. The information writing device may write identifying information about the individual unit dose medication to the unit dose packaging in response to the unit dose medication being identified by comparison with the database of known medications. The information writing device may include a printer configured to print a barcode to the unit dose packaging and/or an RFID encoder configured to encode an RFID tag associated with the unit dose packaging.

The unit dose packaging of some embodiments may be arranged in a continuous dose packaging strip, where the apparatus may be configured to separate a unit dose package from the unit dose packaging strip in response to receiving identifying information thereon. The apparatus of example embodiments may include a comparator configured to compare the individual unit dose medication to the database of known medications. The comparator may be configured to compare a color of the individual unit dose medication to the colors and/or shape of medications in the database of known medications.

Example embodiments of the present invention may provide a computer program product including at least one non-transitory computer-readable storage medium having computer-executable program code instructions stored therein. The computer-executable program code instructions may include program code instructions to cause an individual unit dose medication to be dispensed to a unit dose package, program code instructions to capture an image of the individual unit dose medication, program code instructions to compare the captured image of the individual unit dose medication to a database of known medications, program code instructions to identify the individual unit dose medication in response to the captured image of the individual unit dose medication satisfying a confidence threshold match to one of the known medications.

The computer program product of example embodiments may further include program code instructions to provide identifying information about the individual dose medication to be written to the unit dose package in response to the individual unit dose medication being identified. The program code instructions to provide identifying information about the individual unit dose medication to be written to the unit dose package includes program code instructions to provide a barcode to be written to the unit dose package. The program code instructions to provide identifying information about the individual unit dose medication to be written to the unit dose package may include program code instructions to cause an RFID encoder to encode an RFID tag of the unit dose package with the identifying information. The computer program product of some embodiments may include program code instructions to reject the individual unit dose medication in response to the captured image of the individual unit dose medication being below a confidence threshold match to one of the known medications.

Example embodiments of the present invention may further provide for an automated dispensing system that includes an information reading device configured to obtain identifying information from a unit dose package, an image capture device configured to capture an image of a unit dose medication contained within the unit dose package, and a database of known medications. The database of known medications may contain information regarding the physical appearance of each of the known medications, where the captured image of the unit dose medication contained within the unit dose package may be compared with the information regarding the physical appearance of a medication corresponding to the identifying information. In response to the identifying information satisfying a confidence threshold match to the unit dose medication of the captured image, the unit dose package may be approved for receipt within the automated dispensing system.

### BRIEF DESCRIPTION OF THE SEVERAL VIEWS OF THE DRAWINGS

Reference will now be made to the accompanying drawings, which are not necessarily drawn to scale, and wherein:

FIG. 1 illustrates a system that can be used in conjunction with various embodiments of the present invention;

FIG. 2 illustrates a schematic diagram of an automated packaging station controller according to an example embodiment of the present invention;

FIG. 3 illustrates an example embodiment of an automated dispensing system which may benefit from example embodiments of the present invention;

FIG. 4 illustrates an example embodiment of a unit dose of medication in a unit dose package according to an example embodiment of the present invention;

FIG. 5 is an illustration of an automated packaging station according to an example embodiment of the present invention; and

FIG. 6 is a flowchart of a method for identifying individual unit doses of medication.

### DETAILED DESCRIPTION

Embodiments of the present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. The terms top, bottom, side, up, down, upwards, downwards, vertical, horizontal, and the like as used below do not imply a required limitation in all embodiments of the present invention but rather are used herein to help describe relative direction or orientation in exemplary embodiments illustrated in the figures.

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

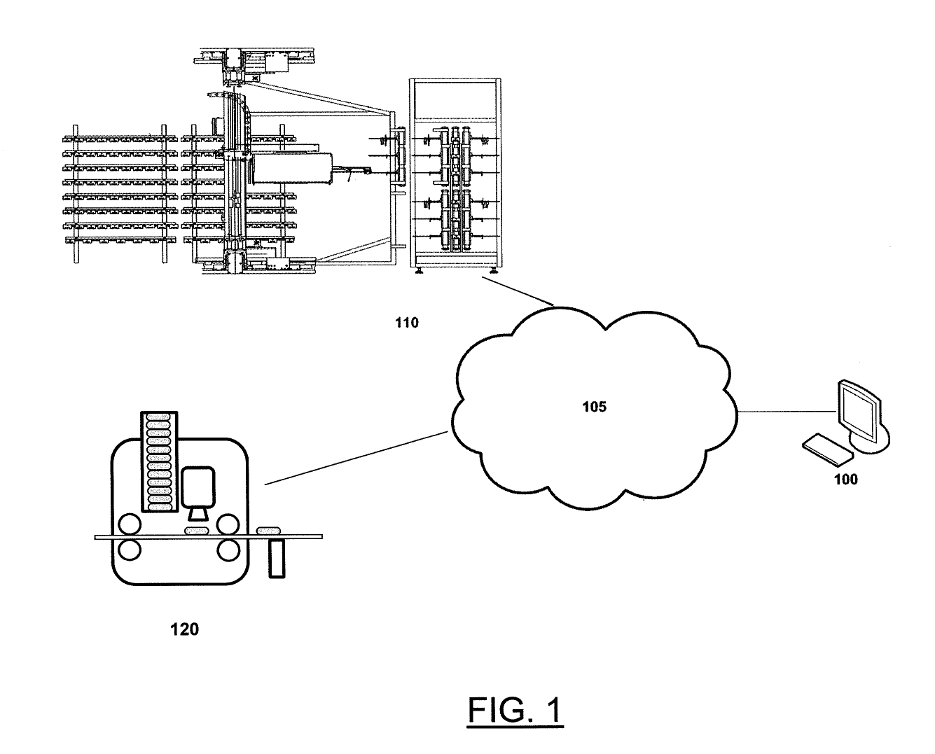

FIG. 1 provides an illustration of a system that can be used in conjunction with various embodiments of the present invention. As shown in FIG. 1, an example embodiment of the system may include an automated dispensing system 110, one or more networks 105, and an automated packaging station 120. Embodiments may include various other devices which may be in communication with the one or more networks 105, such as an approval station 100 which may be used for manual review and/or audit of an automated process performed by one or both of the automated dispensing system 110 and the automated packaging station 120. Embodiments may further include other network entities from which data may be received from or transmitted to, as will be described further below. Each of the components of the system may be in electronic communication with, for example, one another over the same or different wireless or wired networks (e.g., network 105) including, for example, a wired or wireless Personal Area Network (PAN), Local Area Network (LAN), Metropolitan Area Network (MAN), Wide Area Network (WAN), or the like. Additionally, while FIG. 1 illustrates the various system entities as separate, standalone entities, the various embodiments are not limited to this particular architecture.

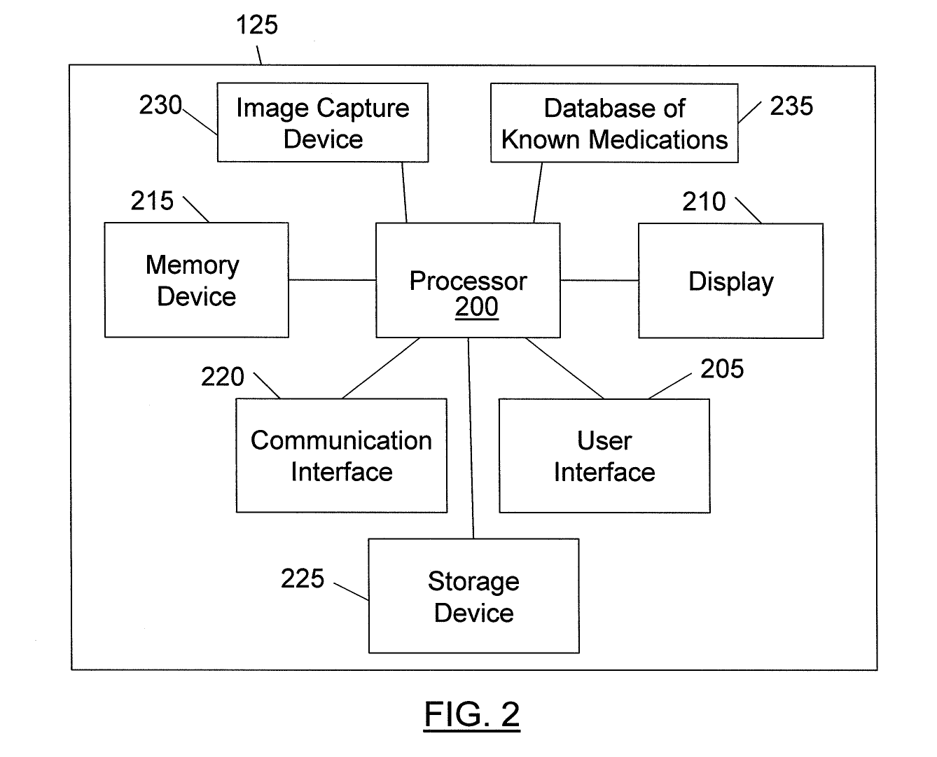

Example embodiments of the automated packaging station 120 as described herein may include a controller configured to control or otherwise monitor and facilitate activities performed at the automated packaging station 120. FIG. 2 provides a schematic of an example embodiment of a controller 125 of an automated packaging station 120. In general, the term “controller” may refer to, for example, any computer, computing device, mobile phone, desktop, tablet, notebook or laptop, distributed system, server, blade, gateway, switch, processing device, or combination of processing devices adapted to perform the functions described herein. The automated packaging station controller 125 may include, be associated with, or be in communication with a variety of computing entities, such as pharmacy inventory management systems, a medication identification database, medication dispensing units, data storage/facilitation computing entities, or other devices that may interface with inventory management, dispensing, replenishing, etc. While example embodiments of automated dispensing systems may be implemented in virtually any setting which may benefit from automated dispensing of articles, embodiments described herein will be described generally with respect to the field of healthcare in which medications may be dispensed for patients or caregivers. However, it is appreciated that embodiments of the present invention may apply to various other embodiments of automated dispensing systems and devices.

As will be understood from FIG. 2, in one embodiment, the automated packaging station controller 125 may include a processor 200 that communicates with other elements of the automated packaging station controller 125 via a system interface or bus. The processor 200 may be embodied in a number of different ways. For example, the processor 200 may be embodied as a processing element, processing circuitry, a coprocessor, a controller or various other processing devices including integrated circuits such as, for example, an application specific integrated circuit (ASIC), a field programmable gate array (FPGA), a hardware accelerator, and/or the like.

In an example embodiment, the processor 200 may be configured to execute instructions stored in memory or otherwise accessible to the processor 200. As such, whether configured by hardware or software methods, or by a combination thereof, the processor 200 may represent an entity capable of performing operations according to embodiments of the present invention when configured accordingly. For example, as discussed in more detail below, the automated packaging station controller 125 may be configured, among other things, to facilitate accurate identification of unit doses of medication. The automated packaging station controller 125 may also be used to write an identification of the identified medication on a unit dose package containing the medication. A user interface 205 may be configured for user input to initiate the automated packaging process or to confirm, advance, or otherwise interact with operations of the automated packaging process. The user interface 205 may include a keyboard, a pointing device, or other mechanism for a user to communicate with the processor 200 and interact with the automated packaging station controller 125.

Automated packaging station controllers according to example embodiments may further include a display 210 which may be configured to present information to a user pertaining to the automated packaging process and to communicate alerts or confirm success of various steps of the automated packaging process. The display 210 may also be configured to present information to a user pertaining to the status of the automated packaging station, information regarding inventory, or any information which may be useful to a user of the device. The display 210 may include a touch screen display which may partially or fully comprise the user interface 205. As noted above, example embodiments may include an automated packaging station that also incorporates the approval station. In such an embodiment, the user interface 205 and display 210 may be used for the approval of operations of the packaging process, auditing the automated packaging process, or reviewing rejected, unidentified unit dose medications as will be further detailed below.

The automated packaging station controller 125 may further include or be in communication with an image capture device 230. The image capture device may include a still camera, a video camera, and/or the like. The image capture device 230 of embodiments of the present invention may be used to capture images and/or video of a unit dose of medication once it is dispensed from a hopper containing a plurality of unit doses of medication. Embodiments of the controller may further include or be in communication with a database of known medications 235 which includes identifying information regarding a plurality of medications. The database of known medications 235, as with any of the components of the automated packaging station controller 125, may be located remotely from the controller and may be accessed via a wired or wireless network. As such, the database of known medications may include identifying information for all of the medications configured to be processed by the automated packaging station.

The automated packaging station controller 125 may further include transitory and non-transitory memory device 215, which may include both random access memory (RAM) and read only memory (ROM). The ROM may be used to store a basic input/output system (BIOS) containing the basic routines that help to transfer information to the different elements within the automated packaging station controller 125.

In addition, in one embodiment, the automated packaging station controller 125 may include at least one storage device 225, such as a hard disk drive, a CD drive, and/or an optical disk drive for storing information on various computer-readable media. The storage device(s) 225 and its associated computer-readable media may provide non-volatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, and/or the like. The storage device may be configured to store, for example, an audit trail of medications identified and/or packaged, operations, errors, alerts, and manual identification of medications rejected by the identification system described below.

Furthermore, a number of executable instructions, applications, scripts, program modules, and/or the like may be stored by the various storage devices 225 and/or within memory device 215. As discussed in more detail below, these executable instructions, applications, program modules, and/or the like may control certain aspects of the operation of the automated packaging station controller 125 with the assistance of the processor 200 and operating system, although their functionality need not be modularized. In addition to the program modules, the automated packaging station controller 125 may store or be in communication with one or more databases.

Also located within the automated packaging station controller 125, in one embodiment, is a communication interface 220 for interfacing with various computing entities. This communication may be via the same or different wired or wireless networks (or a combination of wired and wireless networks). For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the automated storage device controller 100 may be configured to communicate via wireless external communication networks using any of a variety of protocols, such as 802.11, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth™ protocols, wireless universal serial bus (USB) protocols, and/or any other wireless protocol.

It will be appreciated that one or more of the automated packaging station controller's 125 components may be located remotely from other automated packaging station controller components. For example the storage device 225 may be located on a remote network entity. Furthermore, one or more of the components may be combined and additional components performing functions described herein may be included in the automated packaging station controller 125.

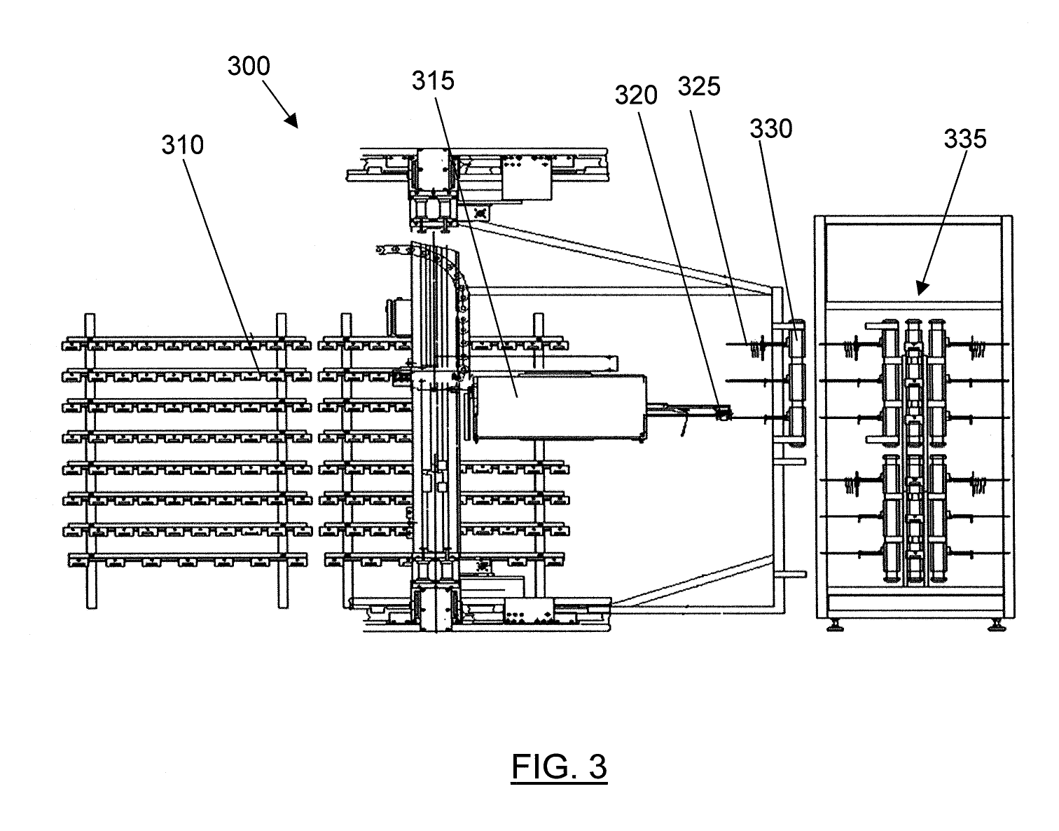

In one embodiment, an automated dispensing system may be used to hold/store/dispense various medications. Such dispensing systems may be used in a variety of environments, including retail pharmacies, central fill pharmacies, hospitals, etc. FIG. 3 illustrates an example embodiment of an automated dispensing system 300 which may be configured to automatically dispense individual unit dose packages of medication in response to receiving a prescription order. Automated dispensing systems 300 which may benefit from example embodiments of the present invention may include a storage rack 310 which stores medication, such as unit dose packages, a robotic system 315 for retrieving the stored medications, where the robotic system 315 includes an end-of-arm-tool for moving the medications, and a dispensing area 335 where medications are dispensed for retrieval by a nurse, doctor, pharmacy technician, etc. In some embodiments, the dispensing system 300 may include bulk transfer devices, such as the portable carrier 330 which is configured to hold multiple medications for faster transfer between the storage rack 310 and the dispensing area 335.

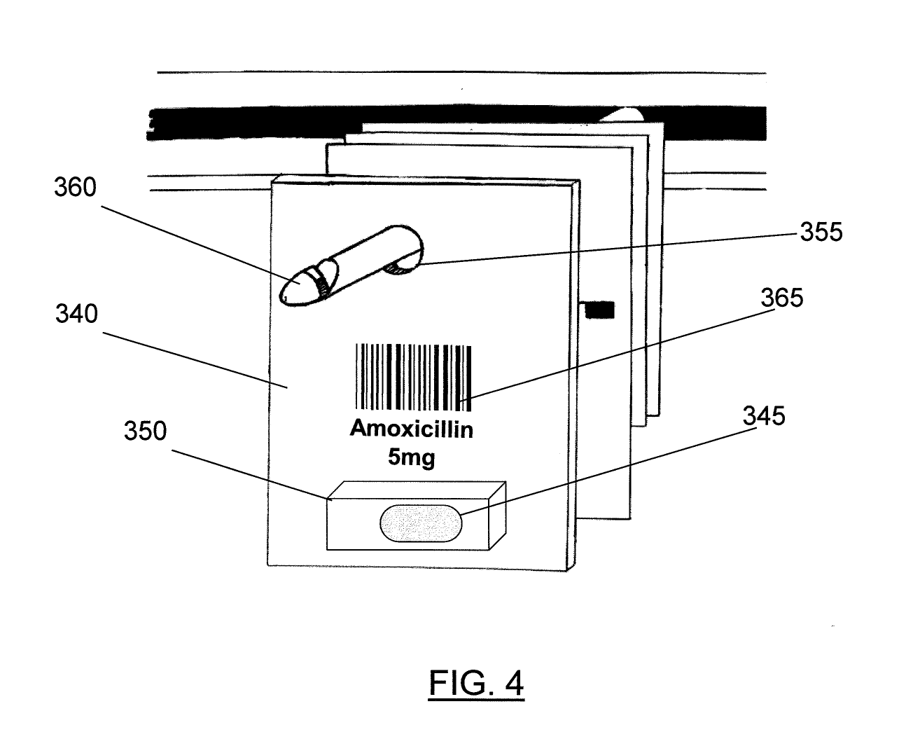

Automated dispensing systems as described above and illustrated in FIG. 3 may require specific packaging that is compatible with the robotic system 315 and the end-of-arm-tool 320. An illustration of an example embodiment of such packaging is illustrated in FIG. 4 which depicts a blister-pack type package 350 with a backing 340. The blister-pack 350 carries the medication 345 while the backing may include a hole 355 configured to receive a rod 360 there through. The automated dispensing system 300 may include a plurality of rods, such as rod 360 of FIG. 3 on which medications may be stored. While the illustrated example of FIG. 4 depicts a blister-pack type package, embodiments implementing a rod storage system may include bags, boxes, or any other packaging which can be stored on rods. Further, while the illustrated dispensing system of FIG. 3 and the medication packaging of FIG. 4 are configured to be stored on rod-type storage systems, various other forms of storage may be implemented in further embodiments of the present invention. For example shelf-based storage on which boxes or structured packaging for medication is held for retrieval by a robotic system or clamp-based storage in which various types of packaging may be clipped for storage and retrieval by a robotic system, among others. As such, the type of packaging illustrated herein and the type of automated dispensing system are merely examples and should not be construed as limiting.

As outlined above, the unit doses of medication that are handled by some embodiments of automated dispensing systems may require specific compatible packaging to be accurately and repeatably dispensed. Automated dispensing systems are generally implemented in environments where large quantities of medications are dispensed routinely, such as hospitals, central fill pharmacies serving several hospitals, healthcare facilities, and the like. As such, automated dispensing systems may dispense thousands to hundreds of thousands of individual unit doses annually.

In order to stock automated dispensing systems with inventory, medication must be packaged in the appropriate packaging. The packaging, as illustrated in FIG. 4, may require specific identification 365 which may include an identifying barcode (one-dimension or two-dimension), a name, an encoded radio frequency identification (RNID) chip, or other identifying indicia. It is imperative that the medication contained within the packaging match the identifying information contained on the packaging. As automated dispensing systems and other devices, such as bed-side scanners used by nurses, may rely on the identification on the packaging, the identifying information must be correct. Further, as a nurse, doctor, or patient may not know what the medication should look like, and because many medications resemble one another, it is important to properly identify the medication to avoid a patient receiving the incorrect medication (either type or dose).

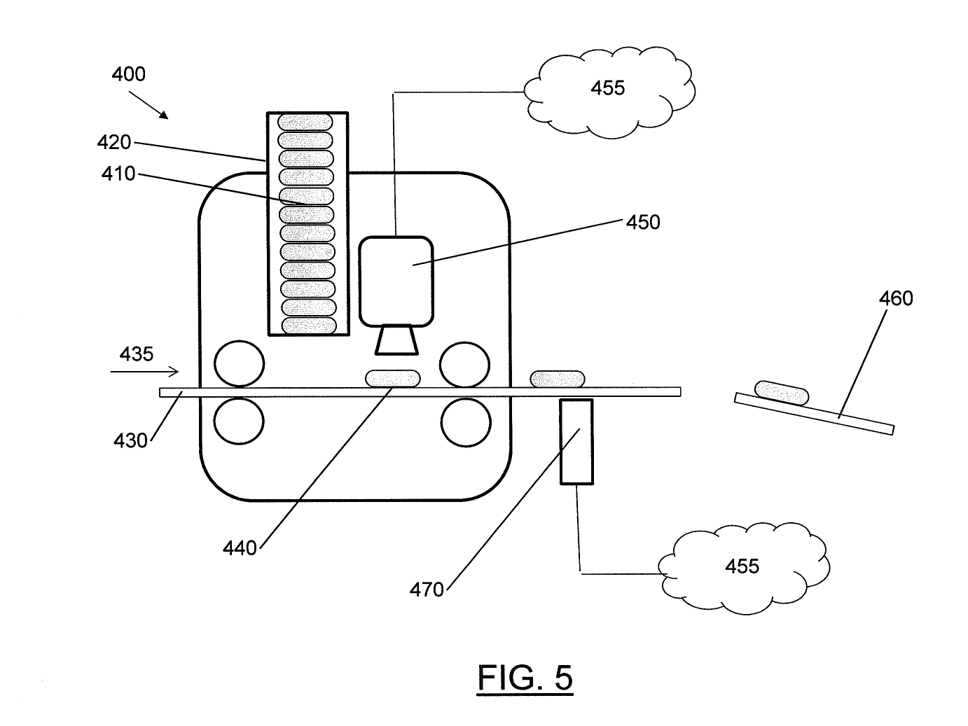

Embodiments of the present invention provide a method, apparatus, and computer program product to identify medication such that it can be properly labeled and handled throughout the dispensing process. FIG. 5 illustrates an example embodiment of an identification system implemented in an automated packaging station 400 in accordance with the present invention. In the illustrated embodiment, a plurality of unit doses of medication 410 is loaded into a hopper 420 of the automated packaging station 400. A packaging material 430 enters the automated packaging station 400 in the direction of arrow 435. The packaging material 430 may be any suitable packaging material for a variety of packaging types. For example, the packaging type may be a bag and the packaging material 430 may be a cellophane, plastic (e.g., high-density polyethylene (HDPE), low-density polyethylene (LDPE), linear-low density polyethylene (LLDPE), etc.), or any other suitable material. The packaging type may optionally be a blister-pack type package with the packaging material 430 being the backing (e.g., foil, cardstock, etc.) or the packaging material may be the blister portion (e.g., plastics, foils, etc.).

The packaging material 430 may enter the packaging station and receive therein or thereon an individual unit dose of medication 440. The unit dose of medication 440 may be dispensed by a mechanism (not shown) on the hopper 420 which serves to singulate or dispense a single unit dose at a time. While the singulation mechanism is not shown, any suitable singulation mechanism may be implemented, such as a water-wheel style, an aperture style, or any common method as appreciated by one of ordinary skill in the art.

Once an individual unit dose of medication 440 is received on the packaging material, an image of the unit dose of medication 440 may be captured by an image capture device 450 which may be any type of image capture device as outlined above with respect to image capture device 230 of FIG. 2. While the illustrated embodiment includes an image captured of the individual unit dose of medication 440 once the unit dose is received on or in the packaging material 430, embodiments may capture an image of the unit dose after dispensing from the hopper 420, but before the unit dose is received in or on the packaging material 430. Such an embodiment may capture an image of the unit dose of medication 440 in a pre-stage area that may be configured with improved lighting or contrasting background color in order to facilitate improved image capture. Optionally, in embodiments where the image of the unit dose medication 440 is captured in or on the packaging material 430, the packaging material may be selected based on a contrasting color or other characteristics which allow for an improved image of the unit dose of medication 440 to be captured.

The image of the unit dose of medication 440 may be transmitted to a processor (e.g., processor 220) or to a remote system for identification. The image capture device 450 may communicate with a processor or remote system via a wired or wireless connection, such as by a connection with a network 455 as illustrated in FIG. 5. The captured image of the unit dose medication 440 may be compared against a database (which may exist on a controller such as controller 125 of FIG. 2, or is otherwise accessible via a network 455), in order to identify the medication (both medication type and dose) of the unit dose 440.

The comparison of the image of the unit dose of medication 440 with the database may occur in a variety of ways. For example, a processor (e.g., processor 220) may analyze the captured image for a unit dose color, a unit dose shape, a unit dose size, indicia disposed on the unit dose, or any other identifying characteristics. These identifying characteristics may then be compared against a database of identifying characteristics to determine a match within the database of known medications. Upon determining a match, the unit dose medication 440 may be identified. Additionally or alternatively, the comparison of the image of the unit dose of medication 440 with the database may be based on an image comparison between the captured image and a database containing images of known medications. Upon determining an image in the database containing images of known medications that matches the captured image of the unit dose of medication 440, the medication may be positively identified.

While the above described mechanisms for identifying a unit dose of medication describe determining a “match” between the captured image and known medications in a database, the “match” may be based on a confidence level. For example, as each captured image for each unit dose of medication may vary to some degree, exact matches for the captured image may not be found. Therefore, to improve the rate at which medications are identified, known medications in the database that match a captured image of a unit dose of medication above a threshold level may be considered a “match.”

In an example embodiment of establishing a match, a captured image of a unit dose of medication may include where a medication from the database of known medications matches the color, shape, and size of the medication in a captured image, but the indicia on the medication in the captured image is only a partial match to the indicia of the medication from the database of known medications, the match may be established. Since indicia may be difficult to read or may be obscured during the manufacturing process, a clear identification of the indicia may not be possible. As such, matching all other attributes and partially matching the indicia of the medication may satisfy the threshold above which it is determined that the medication of the image matches the medication of the known database of medications.

The threshold confidence level which must be satisfied to establish a match between a unit dose of medication in a captured image and the database of known medications may be variable and may be calibrated in order to achieve a minimum accuracy rate (e.g., 99.9999%). The threshold may also vary depending upon the characteristics of the medication. For example, many medications are small, white pills. As such, when a white pill is the unit dose of medication in the captured image, the confidence threshold that must be satisfied may be substantially higher than if the unit dose of medication in the captured image is a pink and purple capsule, where the known database includes only one medication unit dose with a pink and purple capsule.

The threshold confidence level may be a weighted formula based upon the various features compared between the captured image and the database of known medications. For example, the color of a medication may be allowed to vary up to 5% on an established scale, whereas the shape of a unit dose of medication may only be allowed to vary 2% from an established shape.

Upon successful identification of the unit dose of medication 440 (e.g., upon the processor 220 establishing that the unit dose medication of the captured image satisfies the confidence threshold for a medication in the database of known medications), the unit dose of medication 440 is identified. In response to the identification of the unit dose of medication 440, identifying indicia may be written to the unit dose package of the medication.

The identifying indicia written to the unit dose package 460 may be written by an information writing device, which may include a barcode printer (e.g., a direct thermal printer), a dot-matrix printer, a laser printer, a label printer (where the labels are subsequently affixed to the unit dose package), etc. The information writing device may additionally or alternatively be a device configured to encode non-visible information to the unit dose package, such as a radio frequency identification (RFID) encoder, where the unit dose package includes a RFID chip or tag.

FIG. 5 illustrates an information writing device 470 which may be any of the above mentioned types of devices, configured to write identifying information to the unit dose package 460. The information written may be determined based upon the identification of the unit dose of medication received from, for example, the processor 220. The information may include the type of medication, the dosage, physical identifying characteristics of the unit dose of medication, an expiration date, a packaging date, etc.

The unit dose package of FIG. 4 illustrates an example embodiment of identifying information 365 including a medication name (amoxicillin), a medication dose (5 milligrams), and a barcode. The barcode may include redundant information as is presented in text such that a device used to scan the medication (e.g., a barcode scanner), may identify the medication for purposes of confirmation or initial identification. The information encoded to a barcode or RFID chip may include more or less detail than the information presented in text. For example, an expiration date, medication source information, or other information may be encoded into the computer readable barcode or RFID chip.

In an example embodiment, a unit dose of medication 440 may be dispensed from the hopper 420 onto packaging material 430. Upon identification of the medication using an image of the unit dose of medication 440 captured by the image capture device 450, the packaging material 430 may be printed or encoded with information regarding the identification of the medication. The packaging material may be separated or singulated before or after the printing/encoding in order to make a unit dose package 460 for the individual unit dose medication. The unit dose package 460 may subsequently be delivered to an automated dispensing system, such as in FIG. 3, for stocking as inventory.

The automated dispensing system of example embodiments may receive the unit dose package on a rod, as shown in FIG. 4. Alternatively or additionally, the unit dose packages may be of a different form compatible with storage of different types, such as shelves, hooks, clips, or the like as outlined above. According to embodiments, the end-of-arm tool 320 of the automated dispensing system may include an information reading device (e.g., a barcode scanner, an image capture device, an RFID reader, etc.) to read the identification information 365 that was written to the unit dose package as shown in FIG. 4. Alternatively or additionally, an information reading device may be located at a loading station for the automated dispensing system. Upon reading the identification information, the automated dispensing system may reference the database of known medications to ascertain what the identified medication should look like. An image of the unit dose medication in the unit dose package may be captured by the automated dispensing system, such as by an image capture device attached to the end-of-arm-tool. The captured image may be compared against the image of the identified medication stored in the database of known medications.

Upon comparing the captured image against the database of known medications, the automated dispensing system may then verify if the medication unit dose contained in the unit dose package matches the identifying information on the unit dose package. If the captured image of the packaged medication unit dose satisfies a threshold confidence level that it matches the visual appearance stored in the database of known medications, then the medication unit dose is approved and may be moved to a storage location within the automated dispensing device for subsequent dispensing. If the image captured of the medication unit dose does not satisfy a threshold confidence level of a match, then the unit dose package containing the medication may be set aside for manual review.

The identification information written to the unit dose package may also be used to identify the unit dose of medication anywhere during the distribution process, such as at a nurse station, at a patient's bedside, at a central pharmacy, etc.

While the above examples illustrate example embodiments in which the unit dose of medication is positively identified, embodiments of the invention further provide for identification of medication when the identification system cannot automatically positively identify the unit dose medication. In an embodiment in which the confidence threshold of the medication is not satisfied. For example, if a captured image of a unit dose of medication is too dark, too blurred, or if the physical appearance of the medication does not closely match a medication in the database of known medications, the confidence threshold may not be satisfied. Upon failing to satisfy the confidence threshold for the identification of a particular unit dose of medication, the medication may be ejected from the automatic packaging station 400. The unit dose may be packaged or may remain unpackaged as it is sent to a quarantine area for manual review. The unit dose medication sent to the quarantine area may be later reviewed by a doctor, pharmacist, or other individual with authority to positively identify the unit dose. Upon receiving manual positive identification, the unit dose may be packaged and/or written to with identifying information. Alternatively, medication unit doses for which identification cannot be made automatically may be disposed of.

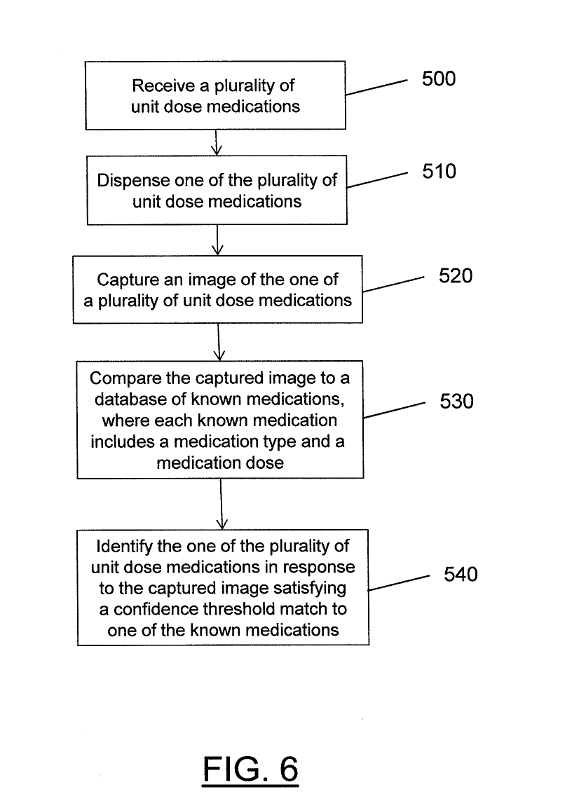

FIG. 6 illustrates an example embodiment of a method for identifying unit doses of medication. A plurality of unit dose medications may be received, as shown at 500. One of the plurality of unit dose medications may be dispensed at 510. An image of the one of the plurality of unit dose medications may be captured at 520. The captured image may then be compared to a database of known medications, where each known medication includes a medication type and a medication dose at 530. The one of the plurality of unit dose medications is then identified in response to the captured image satisfying a confidence threshold match to one of the known medications.

In an example embodiment, an apparatus for performing the method of FIG. 6 above may include a processor (e.g., the processor 200) configured to perform some or each of the operations (500-540) described above. The processor 200 may, for example, be configured to perform the operations (500-540) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 500-540 may comprise, for example, the packaging station controller 125 (or respective different components thereof). Additionally or alternatively, at least by virtue of the fact that the processor 200 may be configured to control or even be embodied as the packaging station controller 125, the processor 200 and/or a device or circuitry for executing instructions or executing an algorithm for processing information as described above may also form example means for performing operations 500-540.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a plurality of unit dose medications;
dispensing one of the plurality of unit dose medications;
capturing an image of the one of a plurality of unit dose medications;
comparing the captured image to a database of known medications, where each known medication includes a medication type and a medication dose; and
identifying the one of the plurality of unit dose medications in response to the captured image satisfying a confidence threshold match to one of the known medications.

2. The method according to claim 1, wherein dispensing one of the plurality of unit dose medications comprises dispensing one of the plurality of unit dose medications to a unit dose package.

3. The method according to claim 2, further comprising writing identifying information to the unit dose package of the one of the plurality of unit dose medications in response to identifying the one of the plurality of unit dose medications.

4. The method according to claim 3, wherein writing identifying information comprises printing a barcode on the unit dose package.

5. The method according to claim 3, wherein writing identifying information comprises encoding a radio frequency identification tag associated with the unit dose package.

6. The method according to claim 1, wherein comparing the captured image to the database of known medications comprises comparing a color of the one of the plurality of unit dose medications with colors of known medications.

7. The method according to claim 1, wherein comparing the captured image to the database of known medications comprises comparing a shape of the one of the plurality of unit dose medications with shapes of known medications.

8. The method according to claim 1, wherein in response to the captured image failing to satisfy a confidence threshold match to one of the known medications, diverting the one of the plurality of unit dose medications to a manual check location.

9. The method according to claim 1, wherein in response to the captured image failing to satisfy a confidence threshold match to one of the known medications, providing an alert.

10. An apparatus for identifying unit dose medication, comprising:
a dispenser for dispensing an individual unit dose medication to unit dose packaging;
an image capture device for capturing an image of the individual unit dose medication;
a database of known medications, wherein the image captured of the individual unit dose medication is compared with the database of known medications in order to identify the individual unit dose medication; and
an information writing device for writing identifying information about the individual unit dose medication to the unit dose packaging in response to the unit dose medication being identified by comparison with the database of known medications.

11. The apparatus according to claim 10, wherein the information writing device comprises a printer configured to print a barcode to the unit dose packaging.

12. The apparatus according to claim 10, wherein the information writing device comprises a radio frequency identification encoder configured to encode a radio frequency identification tag associated with the unit dose packaging.

13. The apparatus according to claim 10, wherein the unit dose packaging is arranged in a continuous unit dose packaging strip, wherein the apparatus is further configured to separate a unit dose package from the unit dose packaging strip in response to receiving identifying information thereon.

14. The apparatus according to claim 10, further comprising a comparator configured to compare the individual unit dose medication to the database of known medications.

15. The apparatus according to claim 14, wherein the comparator is configured to compare a color of the individual unit dose medication to colors of medications in the database of known medications.

16. The apparatus according to claim 14, wherein the comparator is configured to compare a shape and a size of the individual unit dose medication to shapes and sizes of medications in the database of known medications.

17. A computer program product comprising at least one non-transitory computer-readable storage medium having computer-executable program code instructions stored therein, the computer-executable program code instructions comprising:
program code instructions to cause an individual unit dose medication to be dispensed to a unit dose package;
program code instructions to capture an image of the individual unit dose medication;
program code instructions to compare the captured image of the individual unit dose medication to a database of known medications;
program code instructions to identify the individual unit dose medication in response to the captured image of the individual unit dose medication satisfying a confidence threshold match to one of the known medications; and
program code instructions to provide identifying information about the individual unit dose medication to be written to the unit dose package in response to the individual unit dose medication being identified.

18. The computer program product according to claim 17, wherein the program code instructions to provide identifying information about the individual unit dose medication to be written to the unit dose package comprises program code instructions to provide a barcode to be written to the unit dose package.

19. The computer program product according to claim 17, wherein the program code instructions to provide identifying information about the individual unit dose medication to be written to the unit dose package comprises computer program code instructions to cause an radio frequency identification encoder to encode an radio frequency identification tag of the unit dose package with identifying information.

20. The computer program product according to claim 17, further comprising program code instructions to reject the individual unit dose medication in response to the captured image of the individual unit dose medication being below a confidence threshold match to one of the known medications.

21. An automated dispensing system comprising:
an information reading device configured to obtain identifying information from a unit dose package;
an image capture device configured to capture an image of a unit dose medication contained within the unit dose package;
a database of known medications, wherein the database contains information regarding the physical appearance of each of the known medications, wherein the captured image of the unit dose medication contained within the unit dose package is compared with the information regarding the physical appearance of a medication corresponding to the identifying information; and
approving the unit dose package for receipt within the automated dispensing system in response to the medication corresponding to the identifying information satisfying a confidence threshold match to the unit dose medication of the captured image.
